(19) United States
(12) Patent Application Publication
(10) Pub. No.: US 2014/0100196 A1
(43) Pub. Date: Apr. 10, 2014

(54) PHYTOSANITARY MICROEMULSION AND THE PROCEDURE FOR OBTAINING IT

(71) Applicant: RED SURCOS S.A., (unknown)

(72) Inventor: EDMUNDO GERARDO BLUMEL, Buenod Aires, AR (US)

(73) Assignee: RED SURCOS S.A.

(21) Appl. No.: 13/645,859

(22) Filed: Oct. 5, 2012

(51) Int. Cl. A01N 53/14; A01P 7/04; A01P 1/00; A01N 57/16

(52) U.S. Cl. 514/89; 514/521

(57) ABSTRACT

A phytosanitary microemulsion and procedure for obtaining it, wherein the resulting microemulsion is highly stable, with low content of surfactants, achieved due to a combination of an active ingredient, preferably cypermethrin, chlorpirifos or mixtures thereof; refined soy oil; a surfactant at a very low content due to the inclusion of soy oil; a biocide; bidistilled glycerine; xanthan gum and water until reaching the volume.

### STATE OF THE ART OF THE INVENTION

1. Field of the Invention

This invention relates to the field of products and active ingredients for applying in the control of plagues, preferably in agriculture and the industry of plant crops, and more particularly it relates to a formulation of agrochemicals such as phytosanitary products, insecticides, biocides and the like, in the form of stable microemulsions.

2. Description of the Prior Art

Phytosanitary products and agrochemicals have always been products on which strong work have been done for obtaining the best formulation or vehiculization thereof in order to take advantage as much as possible of their active ingredients transferring them to the plant with the least possible losses, either due to lack of adherence to the plant, washing by rains, winds, etc. It has been shown that the best ways for applying these products to crops are the emulsions in which they are presented and although conventional emulsions have had acceptable performances, it has been demonstrated that microemulsions, with a drop size below 0.1 μm, achieve much better results.

A microemulsion is an isotropic and stable liquid mixture which contains an oil, water and surfactants in which products such as herbicides, insecticides, biocides, etc., are combined for being applied on crops, either by any convenient way as for example spraying. There exist two basic types of microemulsions such as water/oil microemulsions, that is, water dispersed in oil, and oil/water, that is, oil dispersed in water. Thus, the two immiscible phases, water and oil, form a system together with the surfactant and, unlike conventional emulsions, microemulsion is formed by simple mixing without requiring high shear forces in its mixing.

In effect, microemulsions differ from emulsions in that microemulsions are one-phase systems closely related to micellar solutions, therefore a microemulsion can be defined as a system of water, oil and surfactant, which is a one-single-phase solution and thermodynamically stable. The more characteristic feature of microemulsions is thermodynamic stability. While an emulsion will always separate over time, a microemulsion is infinitely stable, provided that temperature is kept at a certain range, typical for the formulation.

Correctly mixed microemulsions, meaning those with a high solubility capacity both in water and in oil, give very low interfacial tensions. These microemulsions also show a very high ability for penetrating polar and non-polar materials. Penetration is particularly notable in wood and other heterogeneous materials consisting of polar and non-polar micro domains. Compared with EC emulsions (Emulsionable Concentrates), microemulsions have an extremely great interfacial area between the aqueous and oily domains. Any solid surface in contact with a microemulsion is simultaneously in contact with both aqueous and organic phases.

As explained above, the microemulsion needs the surfactant and bibliography, as well as existing forms for microemulsions, recommends the use of surfactants in amounts over 15% w/v in the preparation for achieving the size of particles that corresponds to the concept of microemulsion for example lower than 0.1 μm. However, petrochemical solvents and surfactants necessary for obtaining EC formulations and microemulsions are, sometimes, more toxic than the active ingredients employed, thus notably affecting environment.

U.S. Pat. No. 8,178,117 describes a formulation comprising a pesticide, such as for example fipronil or alpha-cypermethrin, a non-ionic surfactant, a surfactant such as an alcoxylated triestherylphenyl, an oil and water, being the pesticide present in the aqueous phase in the form of a concentrated suspension and the oil is essentially free from pesticide. That is to say, the active ingredient is present in the aqueous phase in the form of solid particles, therefore it is not microemulsionated, from which it can be deduced that the product can not have the effectiveness that it would supply if it were microemulsionated, that is, forming part of the nanometric drops of the microemulsion.

U.S. Pat. No. 5,827,522 describes a miscible biocide composition in water comprising biologically active biocides dissolved in surfactants selected from the group of alcoxylated castor oil, hydrogenated alcoxylated castor oil and alcoxylated kolophonia. This patent describes formulations for forming a microemulsion once mixed in the spraying solution, that is, they are not compositions wherein the product, prior to its use, is in the form of microemulsion.

Then, it would be very convenient to achieve microemulsions which may have stability over time and reach an effective coverage of the active ingredient but prepared with low content of surfactants, below the quantities recommended by bibliography and existing formulae.

### BRIEF DESCRIPTION OF THE INVENTION

It is therefore an object of this invention to provide a new microemulsion formulation with at least one active ingredient of phytosanitary use, wherein the microemulsion prepared presents surfactant contents much lower than known microemulsions and, however, it does not sacrifice its stability and its effectiveness of coverage fostering a better penetration of the active ingredient into the plant.

It is also an object of this invention to provide a stable phytosanitary microemulsion, which may use a lower quantity of surfactant, comprising at least one active ingredient, such as cypermethrin and/or chlorpirifos, which is dissolved in a fatty acid, such as soy oil wherein both cypermethrin and chlorpirifos are soluble, hence the active ingredients are in the oily phase providing a better dissolution and preservation of the microemulsion.

It is still another object of this invention to provide a stable phytosanitary microemulsion comprising water, active ingredients, surfactants and a plant oil for the dissolution of active ingredients, so that active ingredients are not hydrolyzed, as the case of organophosphorus compounds, being a microemulsion which does not have a harmful action on plant development, and presenting an additional insecticidal action while acting by means of asphyxia on insects due to the obstruction of respiratory orifices, cell plasmosys, and solubilization of chitin of the external skeleton, which allows an increased action rate of the insecticide contained in the formula.

It is also an object of this invention to provide a stable phytosanitary microemulsion comprising water, active ingredients, surfactants and an plant oil for the dissolution of active ingredients, further presenting an adhesive effect exceeding the one of typical microemulsions avoiding washing, rolling and fragmentation of drop when impacting against the leaf surface, also increasing the weight of the sprayed drop, avoiding evaporation and deviation during application.

It is still another object of this invention to provide a stable phytosanitary microemulsion, with low content of surfactants, comprising:

between 1% and 40% of an active ingredient selected from the group consisting of cypermethrin, chlorpirifos and mixtures thereof;

between 10% and 40% of refined soy oil;

between 3% and 6% of a surfactant;

between 0.1% and 0.3% of a biocide;

between 1% and 10% of bidistilled glycerine;

between 2% and 10% of 2% xanthan gum in water, and

between 20% and 50% of water, being all percentages expressed in w/v.

It is still another object of this invention to provide a stable phytosanitary microemulsion as defined in the previous paragraph that when the active ingredient is cypermethrin, the microemulsion further includes between 0.1% and 0.5% of an emulsionated silicon antifoaming agent.

It is further another object of this invention to provide a procedure for obtaining a phytosanitary emulsion according to the invention, wherein the procedure comprises the stages of:

providing such refined soy oil in a container under stirring;

adding such active ingredient to such refined soy oil in the container under stirring;

adding the surfactant in the container, under stirring and mixing until obtaining an homogeneous mixture;

adding water to the homogeneous mixture slowly and under stirring;

adding to the mixture in the container and under stirring the bidistilled glycerine and the biocide, mixing until homogeneity;

adding to the mixture in the container and under stirring the 2% xanthan gum in water;

stirring the mixture in the container until completing the integration of the xanthan gum;

adding water until completing volume.

It is still another object of this invention to provide a procedure as defined in the previous paragraph that when the active ingredient is cypermethrin, a emulsionated silicon antifoaming is added to the microemulsion together with the bidistilled glycerine and the biocide.

### DETAILED DESCRIPTION OF THE INVENTION

Referring now in detail to the microemulsion of the invention, it can be seen that the invention provides microemulsions for formulating active ingredients such as insecticides and preferably for the application of insecticides known as Cypermethrin and Chlorpirifos, as well as the mixture thereof in the same microemulsion. The microemulsions of the invention are highly stable over time and are formulated with low contents of surfactant.

Microemulsions of the invention preferably contain Cypermethrin, Chlorpirifos or the mixture thereof, and formulation is prepared un a mixture of:

between 10% and 40% of refined soy oil;

between 3% and 6% of a surfactant;

between 0.1% and 0.3% of a biocide;

between 1% and 10% of bidistilled glycerine;

between 2% and 10% of 2% xanthan gum in water, and

between 20% and 50% of water, being all percentages expressed in w/v.

In the case that the formulation is based on Cypermethrin as base active ingredient, Cypermethrin shall be present in a rate between 5% and 35% and the microemulsion shall further include between 0.1% and 0.5% of an emulsionated silicon antifoaming agent.

In the case that the formulation is based on Chlorpirifos as base active ingredient, Chlorpirifos shall be present in a rate between 5% and 35% and the microemulsion shall not need to include the emulsionated silicon antifoaming agent. When it is a mixture of Cypermethrin and Chlorpirifos, preferably the percentages shall range so that Cypermethrin shall be present in a rate between 10% and 20% and Chlorpirifos shall be present in a rate between 10% and 25%

In a manner notably distinguishable from microemulsions of the prior art, the microemulsion of this invention has achieved, with low contents of surfactant, between the aforementioned ranges, an effectiveness higher than 40% over traditional formulae, that is, concentrated emulsions EC, achieving performances similar to those of the other more evolved pyrethroids as Lambdacialotrina and at a very lower doses cost, always preserving all the advantages that microemulsions have. Further, the microemulsion of the invention is cheaper than the other microemulsions for the active ingredients described herein.

The absence or poor presence of petrochemical solvents, present in EC formulations and surfactants which are used by known microemulsions at high contents, toxicity is notably reduced that would affect environment.

Inventors have achieved this new formulation with low contents of surfactant, preserving the functional features of a microemulsion, adding refined soy oil to the formulation, which is preferably added in the initial stage for preparing the mixture.

The microemulsion formulated with Chlorpirifos has also employ surfactant contents below than those contents recommended by bibliography, exceeding the 15% w/v in the preparation in order to achieve the particle size suitable for a microemulsion. With Chlorpirifos, the invention ha achieved an equally effective microemulsion with the low contents indicated above. It should be added to this that organophosphorous active ingredients, as Chlorpirifos, are hydrolysable, hence they could not be part of an aqueous formulation because they would break down.

Formulations obtained with low surfactant contents, due to the use of refined soy oil, achieved an effective coverage of the active ingredient, isolating it from water of the formula, that is, continuous phase, allowing its stability over time, both in the commercial presentation and in the water of the spraying solution.

These formulations have been proved in field and showed an efficiency higher than 40% over traditional formulae of concentrated emulsions EC.

This invention is best illustrated according the following examples, which should not be construed as a limitation to the scope thereof. In all Formulae, all percentage rates are expressed in weight per volume w/v.

### Example 1

### Formula of Cypermethrin 25% w/v

### White Microemulsion

25.00% de 100% technical grade cypermethrin;

33.30% of refined soy oil;

3.70% of a surfactant;

0.18% of a biocide;

2.77% of bidistilled glycerine;

2.60% of 2% xanthan gum in water;

0.10% of emulsionated silicon antifoaming agent, and

33.60% of water.

### Example 2

### Formula of Chlorpirifos at 25% w/v

### White Microemulsion

25.00% de 100% technical grade chlorpirifos;

36.10% of refined soy oil;

4.00% of a surfactant;

0.20% of a biocide;

2.00% of bidistilled glycerine;

4.40% of 2% xanthan gum in water, and

31.80% of water.

### Example 3

### Formula of Chlorpirifos at 18% w/v and Cypermethrin at 2.5% w/v

### White Microemulsion

2.50% de 100% technical grade cypermethrin;

18.00% de 100% technical grade chlorpirifos;

33.30% of refined soy oil;

4.00% of a surfactant;

0.20% of a biocide;

2.00% of bidistilled glycerine;

0.20% of emulsionated silicon antifoaming agent, and

34.90% of water.

In all examples, the surfactant employed has been a mixture of lineal alkylbencene sulfonates and ethoxylated derivatives in isobutanol in the following rates w/v: 3% and 6%.

According to other aspect, the invention also provides a procedure for obtaining a phytosanitary emulsion useable for obtaining any of the aforementioned examples, wherein the procedure comprises the stages of:

providing such refined soy oil in a container under stirring;

adding such active ingredient to such refined soy oil in the container under stirring;

adding the surfactant in the container, under stirring and mixing until obtaining an homogeneous mixture;

adding water to the homogeneous mixture slowly and under stirring;

adding to the mixture in the container and under stirring the bidistilled glycerine and the biocide, mixing until homogeneity;

adding to the mixture in the container and under stirring la 2% xanthan gum in water;

stirring the mixture in the container until completing the integration de la xanthan gum;

adding the water until completing the volume.

For the case in which formulation is based on Cypermethrin as base active ingredient, in the stage of adding the bidistilled glycerine and the biocide, it will also be added a emulsionated silicon antifoaming agent in the rates already defined above. Also, such stage of stirring the mixture in the container, until completing the integration of the xanthan gum, is carried out during 30 minutes. Also, previous to the stage of adding the 2% xanthan gum in water, such xanthan gum is hydrated at least during 24 hours.

It should be highlighted that the procedure of the invention doe not require special equipments, such as stirring organs with high shear effort, or special care in the parameter of the process. These formulations cab be achieved in standard mixing facilities since they have a markedly negative free energy (Gibbs) which offers spontaneity of micellar formation.

The formulation of this invention, as indicated above, presents a better performance on the basis that both cypermethrin and chlorpirifos are soluble in fatty acids, preferably in soy oil, hence active ingredients are present in the oily phase, with the benefits indicated in this description. Microemulsions of the invention do not use surfactants as solvents of the active ingredients, but soy oil, so that the microemulsion, containing water, can be marketed in that form preventing that the active ingredient, for example chlorpirifos, from being hydrolyzed.

While formulations of the prior art use surfactants as solvents, such as alcoxylated castor oil or its derivatives, most surfactants are mixtures of anionic surfactants, such as alkylbencenesulfonates, and non-ionic surfactants, such as ethoxylated fatty alcohols. With the plant oil, the microemulsion of the invention does not have harmful actions on the plant development, unlike petroleum derivatives which are most surfactants or organic solvents frequently called with the general terminology of “oil”.

Microemulsions of this invention also present an additional insecticidal action acting by means of asphyxia on insects due to the obstruction of respiratory orifices, cell plasmosys, and solubilization of chitin of the external skeleton, which allows an increased action rate of the insecticide contained in the formula. In combination with xanthan gum, a adhesive effect exceeding that of typical microemulsions avoiding washing, rolling and fragmentation of drop when impacting against the leaf surface, and also increasing the weight of the sprayed drop, thus avoiding evaporation and deviation during application

The formulations of this invention have been subjected to field tests in various opportunities with excellent results. Such studies are not added herein, being them at the disposal of any interested party. By way of example two of them will be transcribed below.

Assessment of Cypermethrin Formulations for Controlling Caterpillar of Leguminous Plants Anticarsia gemmatalis

Technical report carried out by National Institute of Agricultural Technology (INTA), Pergamino Agricultural Experimental Station, on Jul. 31, 2008.

The features of the test performed are the following:

Crop: Soy, DM 4870 cultivar sowed with a spacing of 35 cm between rows

Sowing Date: Dec. 29, 2007

Phenological stage (at the time of application): R5, according to Fehr and Caviness scale (1977)

Intensity of infestation: Average of 48 larvae per row meter

Population structure: medium and big larvae

Size of lots: 10 rows 10 meters long

Experimental design: Completely randomized blocks, with 4 repetitions

Date and hour of application: Mar. 20, 2008; 14 to 15 hours.

Equipment used: manual sprayer with conical nozzle bar

Working pressure: constant of 30 lb/pg²

Flow: Equivalent to 100 liters per hectare

Sampling: number of larvae per meter of soy row with the use of the vertical fabric method (fabric of one meter), and within each lot samples (4) were taken at random

Assessment: previous count, 24 hours, 5, 8, and 12 day after application

Determination of efficiency: Henderson and Tilton

$$\% Mortality = 1 - ( \frac{( TA \times tr . d )}{( TD \times tr . a )} ) \times 100 \qquad Formula$$

A and D=individuals in the control sample (T) before and after application
a and d=individuals in the treated lot (tr.) before and after application

### Treatments

Assessed treatments with their respective doses of application are indicated in Table 1.

TABLE 1
ASSESSMENT OF INSECTICIDES FOR THE CONTROL OF
CATERPILLAR OF LEGUMINOUS PLANTS Anticarsia gemmatalis
(Lepidoptera: Noctuidae) IN SOY CROP

| ACTIVE INGREDIENTS | | DOSES |
|---|---|---|
| AND FORMULATION | TRADE NAME | (cc or g formulation/ha) |
| Cypermethrin 25% EC | KALIBRE 25 EC | 100 cc |
| Cypermethrin 20% ME | Experiment | 60 cc |
| | Cyper 20 ME | |
| Cypermethrin 20% ME | Experiment | 80 cc |
| | Cyper 20 ME | |
| Cypermethrin 20% ME | Experiment | 100 cc |
| | Cyper 20 ME | |
| Cypermethrin 25% E0 | Experiment | 60 cc |
| | Cyper 25 EO | |
| Cypermethrin 25% E0 | Experiment | 80 cc |
| | Cyper 25 EO | |
| Cypermethrin 25% E0 | Experiment | 100 cc |
| | Cyper 25 EO | |
| Sample (without control) | — | — |

Date of application: Mar. 20, 2008
Soy of 1° Var. DM 4870
Phonological stage: R5

### Environmental Conditions at the Time of Application

### Temperature: 29.6° C.

Relative humidity: 42%
Wind: 7 km/h

### Results

Mortality values of Anticarsia gemmatalis obtained in accordance with treatments of cypermethrin formulations, doses and days of assessment after application are indicated in table 2.

TABLE 2
Efficiency of the control of “caterpillar of leguminous
plants” Anticarsia gemmatalis in the soy crop
according to formulations and doses of Cypermethrin
TREATMENTS

| (Formulations and Doses/ha | % MORTALITY (Henderson and Tilton) | | | |
|---|---|---|---|---|
| of Cypermethrin) | 24 hours | 5 Days | 8 Days | 12 Days |
| Cypermethrin 25% EC 100 cc | 83.6 | 95.9 | 96.4 | 0 |
| Cypermethrin 20% ME 60 cc | 72.6 | 88.2 | 80.5 | 0 |
| Cypermethrin 20% ME 80 cc | 79.3 | 94.0 | 91.6 | 12.2 |
| Cypermethrin 20% ME 100 cc | 83.8 | 96.6 | 95.4 | 27.7 |
| Cypermethrin 25% E0 60 cc | 79.5 | 91.8 | 84.5 | 0 |
| Cypermethrin 25% E0 80 cc | 85.7 | 93.9 | 91.6 | 23.8 |
| Cypermethrin 25% E0 100 cc | 89.4 | 95.0 | 92.4 | 31.9 |

The initial action of Cypermethrin in formulations

ME 20% and ME 25% showed a relationship with the assessed doses, avoiding higher level of mortality of Anticarsia by means of the microemulsion formulation 25%, not only exceeding formulation 20% ME but also the traditional formulation of Cypermethrin 25% EC.

5 and 8 days after the application of higher doses of the formulations ME and EO showed a similar performance against the plague, but with a efficiency of control slightly higher when the highest dose is used (100 cc/ha).

12 days after the application, a clear loss of residuality if recorded, being it a complete one in the cases of the formulation of Cypermethrin 25% EC applied to 100 cc/ha and with the formulations ME and EO when they were used at a rate of 60 cc/ha.

Assessment of Formulations of Chlorpirifos for the Control of Caterpillar of Leguminous Plants Anticarsia gemmatalis

Technical report carried out by National Institute of Agricultural Technology (INTA), Pergamino Agricultural Experimental Station, on Jul. 31, 2008.

The features of the test performed are the following:

Crop: Soy, DM 4870 cultivar sowed with a spacing of 35 cm between rows

Sowing Date: Dec. 29, 2007

Phenological stage (at the time of application): R6, according to Fehr and Caviness scale (1977)

Intensity of infestation: Average of 34 larvae per row meter

Population structure: medium and big larvae

Size of lots: 10 rows 10 meters long

Experimental design: Completely randomized blocks, with 4 repetitions

Date and hour of application: Mar. 27, 2008; 14 to 15 hours.

Equipment used: manual sprayer with conical nozzle bar

Working pressure: constant of 30 lb/pg²

Flow: Equivalent to 100 liters per hectare

Sampling: number of larvae per meter of soy row with the use of the vertical fabric method (fabric of one meter), and within each lot samples (4) were taken at random

Assessment: previous count, 24 hours, 4, 11, and 18 days after application

Determination of efficiency: Henderson and Tilton

$$\% Mortality = 1 - ( \frac{( TA \times tr . d )}{( TD \times tr . a )} ) \times 100 \qquad Formula$$

A and D=individuals in the control sample (T) before and after application
a and d=individuals in the treated lot (tr.) before and after application

Treatments

The treatments assessed with their respective doses of application are indicated in Table 1.

TABLE 1
ASSESSMENT OF INSECTICIDES FOR THE CONTROL OF
CATERPILLAR OF LEGUMINOUS PLANTS Anticarsia gemmatalis
(Lepidoptera: Noctuidae) IN SOY CROP

| ACTIVE INGREDIENTS | | DOSES |
|---|---|---|
| AND FORMULATION | TRADE NAME | (cc or g formulation/ha) |
| Chlorpirifos 48% EC | LORSBAN 48 | 800 cc |
| Chlorpirifos 25% ME | Experiment | 480 cc |
| | Ciagro 25 ME | |
| Chlorpirifos 25% ME | Experiment | 640 cc |
| | Ciagro 25 ME | |
| Sample (without control) | — | — |

Date of application: 27 Mar. 2008
Soy of 1° Var. DM 4870
Phenological stage: R6

Environmental Conditions at the Time of Application

Temperature: 24.8° C.

Relative humidity: 65%

Wind: 8 km/h

Results

Mortality values of Anticarsia gemmatalis obtained in accordance with treatments of chlorpirifos formulations, doses and days of assessment after application are indicated in table 2.

TABLE 2
Efficiency of the control of “caterpillar of leguminous
plants” Anticarsia gemmatalis in the soy crop
according to formulations and doses of Chlorpirifos

| TREATMENTS | | | | |
|---|---|---|---|---|
| (Formulation and Doses/ha | % MORTALITY (Henderson and Tilton) | | | |
| of Chlorpirifos) | 24 hours | 4 Days | 11 Days | 18 Days |
| Chlorpirifos 48% EC 800 cc | 85.9 | 98.5 | 93.6 | — |
| Chlorpirifos 25% ME 480 cc | 77.7 | 92.2 | 86.9 | — |
| Chlorpirifos 25% ME 640 cc | 78.3 | 93.0 | 89.9 | — |

(*) Te records of data belonging to the count 18 days after application were not considered for the determination of the % of mortality (according to Henderson and Tillton formula) due to the pronounced reduction of larvae population of Anticarsia in the test.

The assessed doses of the experimental formulation ME 25% of Chlorpirifos has lower efficiency in the control of Anticarsia over the one recorded when using the traditional formulation of such active ingredient (48% EC) at a rate of 800 cc/ha.

Such performance can be observed (table 2) both in it initial action measured 24 hours after application, and 4 and 11 days after it. The maximum efficiency of the tested alternatives was recorded 4 days after application, with 98.5% of mortality for the traditional formulation (at 800 cc/ha) over 92-93% determined with the formulation ME 25% (480 and 640 cc/ha).

1. A stable phytosanitary microemulsion, with low content of surfactants, comprising:
between 1% and 40% of an active ingredient selected from the group consisting of cypermethrin, chlorpyrifos and mixtures thereof;
between 10% and 40% of refined soy oil;
between 3% and 6% of a surfactant;
between 0.18% and 0.3% of a biocide;
between 1% and 10% of bidistilled glycerine;
between 2% and 10% of a 2% solution of xanthan gum in water, and
between 20% and 50% of water, being all percentages expressed in w/v
wherein the active ingredient and the organic solvent provides a lipophilic part of the microemulsión and a hydrophilic part of the microemulsión being comprised of the water.

2. A phytosanitary microemulsion according to claim 1, wherein such active ingredient is cypermethrin at 25% w/v and the microemulsion further includes between 0.1% and 0.5% of an emulsioned silicon antifoaming agent.

3. A phytosanitary microemulsion according to claim 2, comprising:
25.00% of 100% technical grade cypermethrin;
33.30% of refined soy oil;
3.70% of a surfactant;
0.18% of a biocide;
2.77% of bidistilled glycerine;
2.60% of a 2% solution of xanthan gum in water;
0.10% of an emulsioned silicon antifoaming agent, and
33.60% of water.

4. A phytosanitary microemulsion according to claim 1, wherein such active ingredient is chloropyrifos and the microemulsion comprises:
25.00% of 100% technical grade chloropyrifos;
36.10% of refined soy oil;
4.00% of a surfactant;
0.20% of a biocide;
2.00% of bidistilled glycerine;
4.40% of xanthan gum a 2% in water, and
31.80% of water.

5. A phytosanitary microemulsion according to claim 1, wherein such active ingredient is a mixture of cypermethrin and chloropyrifos and the microemulsion comprises:
2.50% of 100% technical grade cypermethrin;
18.00% of 100% technical grade chloropyrifos;
33.30% of refined soy oil;
4.00% of a surfactant;
0.20% of a biocide;
2.00% of bidistilled glycerine;
0.10% of an emulsioned silicon antifoaming agent, and
34.90% of water.

6. A phytosanitary microemulsion according to claim 1, wherein such surfactant comprises a mixture of lineal alkylbencene sulfonates and ethoxylated derivatives in isobutanol.

7. A phytosanitary microemulsion according to claim 6, wherein such mixture of lineal alkylbencene sulfonates and ethoxylated derivatives in isobutanol is composed of the following rates in w/v: 3% and 6%.

8. A procedure for obtaining a phytosanitary emulsion comprising:
between 1% and 40% of an active ingredient selected from the group consisting of cypermethrin, chloropyrifos and mixtures thereof;
between 10% and 40% of refined soy oil;
between 3% and 6% of a surfactant;
between 0.18% and 0.3% of a biocide;
between 1% and 10% of bidistilled glycerine;
between 2% and 10% of a 2% solution of xanthan gum in water, and
between 20% and 50% of water, being all percentages expressed in w/v,
wherein the procedure comprises the stages of:
providing such refined soy oil in a container under stirring;
adding such active ingredient to such refined soy oil in the container under stirring;
adding the surfactant in the container, under stirring and mixing until obtaining an homogeneous mixture;
adding water to the homogeneous mixture slowly and under stirring;
adding to the mixture in the container and under stirring the bidistilled glycerine and the biocide, mixing until homogeneity;
adding to the mixture in the container and under stirring the 2% solution of xanthan gum in water;
stirring the mixture in the container until completing the integration of the xanthan gum solution;
adding the water until completing the volume.

9. A procedure according to claim 8, wherein between 0.1% and 0.5% of an emulsioned silicon antifoaming agent is added together with the bidistilled glycerine and the biocide.

10. A procedure according to claim 8, wherein such stage of stirring the mixture in the container until completing the integration of the xanthan gum is carried out during 30 minutes.

11. A procedure according to claim 8, wherein previous to the stage of adding the 2% xanthan gum in water, such xanthan gum is hydrated for at least 24 hours.
